(19) United States
(12) Patent Application Publication
(10) Pub. No.: US 2026/0027628 A1
(43) Pub. Date: Jan. 29, 2026

(54) DRILL GUIDE FOR REMOVING A STANDOFF AND METHOD OF REMOVING STANDOFF

(71) Applicant: Spirit AeroSystems, Inc., Wichita, KS (US)

(72) Inventors: Bradly R. Hilker, Wichita, KS (US); Timothy W. Reiswig, Wichita, KS (US)

(21) Appl. No.: 18/783,006

(22) Filed: Jul. 24, 2024

(51) Int. Cl. B23B 47/28

(52) U.S. Cl. CPC B23B 47/287

(57) ABSTRACT

A drill guide for removing a standoff fastened to a structure by a plurality of fasteners has a fitting body that defines a standoff receptacle with an open bottom. The fitting body can be pressed onto the standoff to locate the standoff in the standoff receptacle. This makes a close tolerance fit that operably couples the drill guide to the standoff at a keyed position. A plurality of drill bushings are secured to the fitting body. Each drill bushing defines a drill bit passage extending along a respective drilling axis. Each drill bushing is positioned and arranged on the fitting body to be directly above a respective one of the fasteners when the fitting body is in the keyed position in relation to the standoff such that the drill bushing is configured to guide a drill bit inserted into the drill bit passage along the drilling axis for drilling out the fastener.

### FIELD

This disclosure generally pertains to a drill guide for removing a standoff and a method of removing a standoff that has been fastened to a structure with non-removable fasteners such as rivets.

### BACKGROUND

A standoff is an attachment device used for securing other components to larger structures. A standoff can be mounted on the structure and provides a fixed attachment point for securing internal wiring, tubing, ducting, or other components. Standoffs are frequently used in aerostructure manufacture. For example, it is common for a manufacturer to specify a plurality of standoffs for particular locations so that standoffs collectively guide interior wiring, tubing, or ducting along predefined paths.

A standoff is comprised of a base that can be mounted on a structure and an upstanding portion to which another component can be attached. Typically, the base of the standoff includes a flange with pre-formed fastener holes spaced apart from the upstanding attachment feature. A non-removable fastener such as a rivet is inserted through each pre-formed hole to attach the standoff to the structure. It sometimes happens that the standoff is fastened to the structure at the wrong location, e.g., a location that does not meet the specifications for an aerostructure. When this occurs, the standoff must be removed and reinstalled, which requires removing the fasteners.

While non-removable fasteners like rivets offer numerous well-understood advantages for aerostructures and other applications, they are designed to be permanent and are therefore challenging to remove. The typical procedure for removing a rivet fastened to a standoff involves drilling out each of the rivets freehand. The process is time-consuming and requires significant skill to drill out the rivet without damaging the surrounding area. It is particularly challenging when the rivet has a domed head, as is often the case for rivets used with standoffs. Further, the standoff can only be reused if the technician drills perfectly through the preformed fastener hole in the standoff flange and does not enlarge the preformed fastener hole. When the drilling process damages the standoff or alters the standoff in any way, it must be scrapped.

### SUMMARY

In one aspect, a drill guide for removing a standoff fastened to a structure by a plurality of fasteners comprises a fitting body having a bottom portion and a top portion spaced apart along a height. The fitting body defines a standoff receptacle opening through the bottom portion of the fitting body. The fitting body is configured to operably couple to the standoff such that at least a portion of the standoff is received in the standoff receptacle and the fitting body is fitted onto a portion of the standoff in close tolerance, such that the fitting body has a keyed position in relation to the standoff. A plurality of drill bushings are secured to the fitting body. Each drill bushing defines a drill bit passage extending along a respective drilling axis. Each drill bushing is positioned and arranged on the fitting body to be directly above a respective one of the fasteners when the fitting body is in the keyed position in relation to the standoff such that the drill bushing is configured to guide a drill bit inserted into the drill bit passage along the drilling axis for drilling out the fastener.

In another aspect, a method of removing a standoff from a structure after the standoff has been fastened to the structure with a plurality of fasteners comprises press fitting the drill guide onto the standoff whereby the drill guide is positioned at a keyed position in relation to the standoff. Each of a plurality of drill bushings of the drill guide is used to guide a drill bit along respective drilling axes to drill out a respective fastener securing the standoff to the structure.

Other aspects will be in part apparent and in part pointed out hereinafter.

### BRIEF DESCRIPTION OF THE DRAWINGS

FIG. 1 is a perspective of a standoff;

FIG. 2 is a perspective of a drill guide for removing the standoff of FIG. 1 from a structure;

FIG. 3 is another perspective of the drill guide;

FIG. 4 is an elevation of the drill guide;

FIG. 5 is a cross section taken in the plane of line 5-5 of FIG. 4.

FIG. 6 is an exploded perspective of the drill guide;

FIG. 7 is a perspective of the drill guide operably coupled to the standoff of FIG. 1;

FIG. 8 is another perspective of the drill guide operably coupled to the standoff;

FIG. 9 is a cross section similar to FIG. 5, but showing the drill guide operably coupled to the standoff and showing a drill bit drilling out a fastener of the standoff using the drill guide;

FIG. 10 is a perspective of another embodiment of a drill guide for removing the standoff of FIG. 1;

FIG. 11 is another perspective of the drill guide of FIG. 10;

FIG. 12 is a perspective of the drill guide of FIG. 10 operably coupled to the standoff of FIG. 1 wherein the standoff is fastened to a near-edge structure;

FIG. 13 is a perspective of another embodiment of a standoff;

FIG. 14 is a perspective of a drill guide for removing the standoff of FIG. 12 from a structure;

FIG. 15 is another perspective of the drill guide of FIG. 13;

FIG. 16 is a perspective of the drill guide of FIG. 13 operably coupled to the standoff of FIG. 12;

FIG. 17 is a perspective of another embodiment of a standoff;

FIG. 18 is a perspective of a drill guide for removing the standoff of FIG. 17;

FIG. 19 is another perspective of the drill guide of FIG. 18; and

FIG. 20 is a perspective of the drill guide of FIG. 18 operably coupled to the standoff of FIG. 17.

Corresponding parts are given corresponding reference characters throughout the drawings.

### DETAILED DESCRIPTION

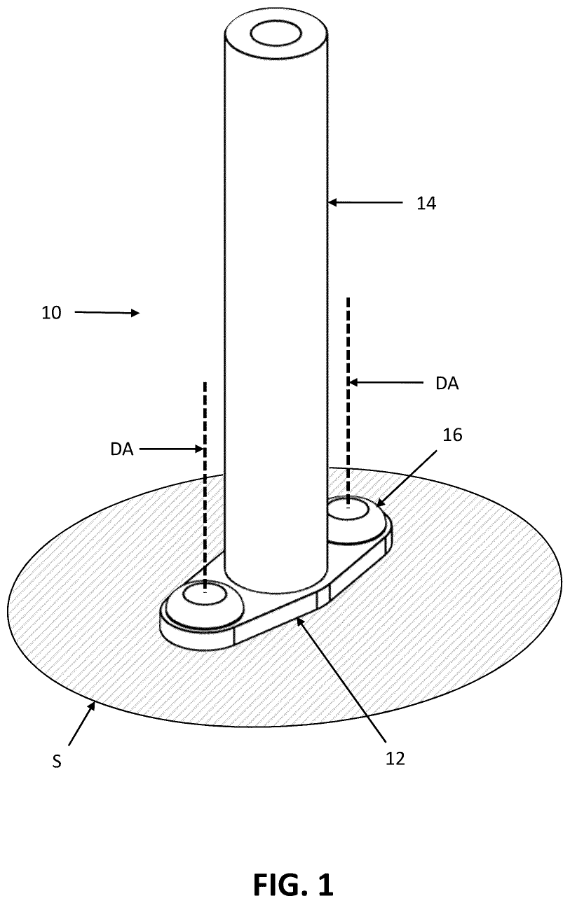

Referring to FIG. 1, an example of a typical standoff is shown and generally indicated at reference number 10. The standoff 10 comprises a flange 12 for supporting the standoff on a structure S and an upstanding portion 14 extending from the top of the flange. In the illustrated embodiment, the upstanding portion 14 comprises a vertical arm extending upward from a central region of the flange. Non-removable fasteners 16 (e.g., rivets) extend through pre-drilled holes in the flange and fasten the standoff 10 to the structure S. In the illustrated embodiment, the fasteners 16 have domed heads and are located on opposite sides of the arm 14 such that the arm is centered widthwise between the fasteners.

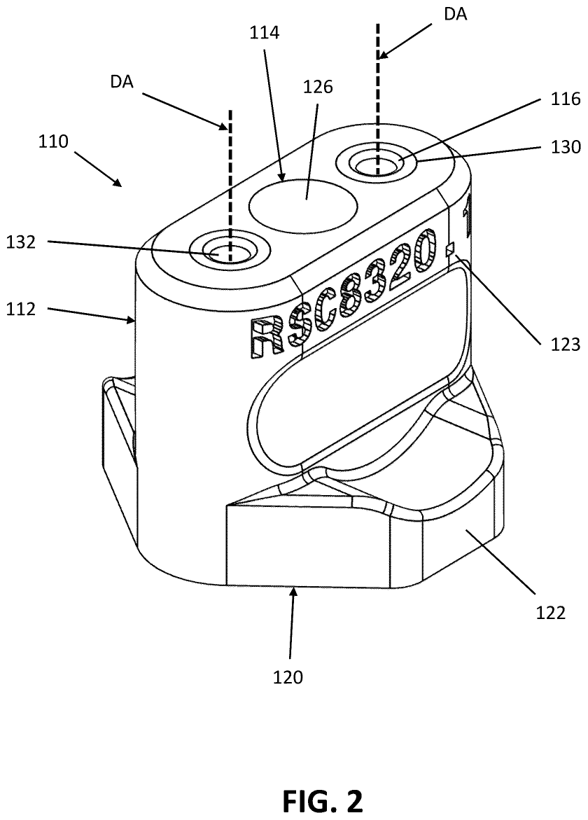

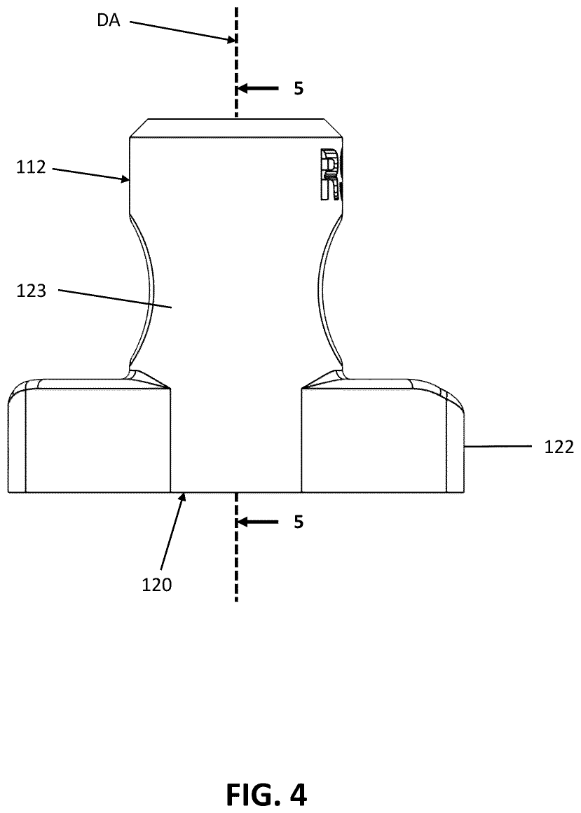

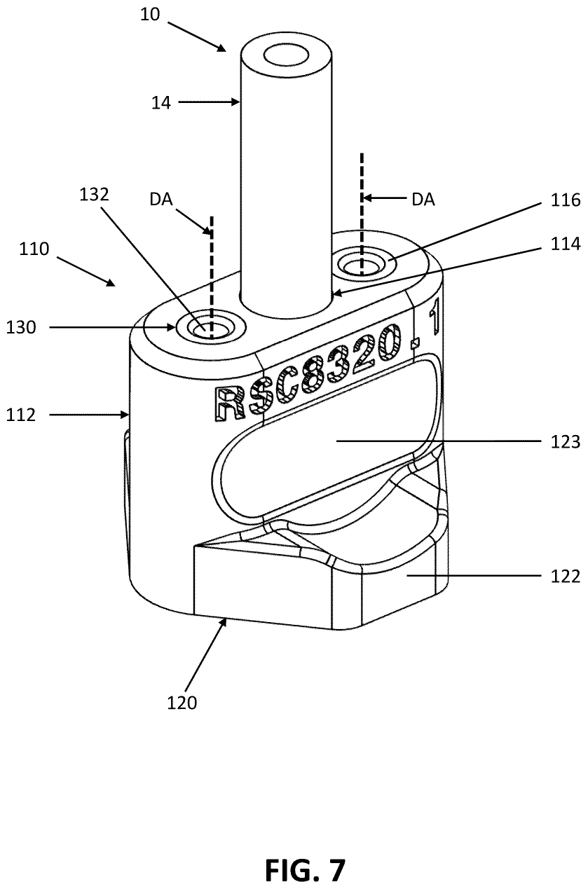

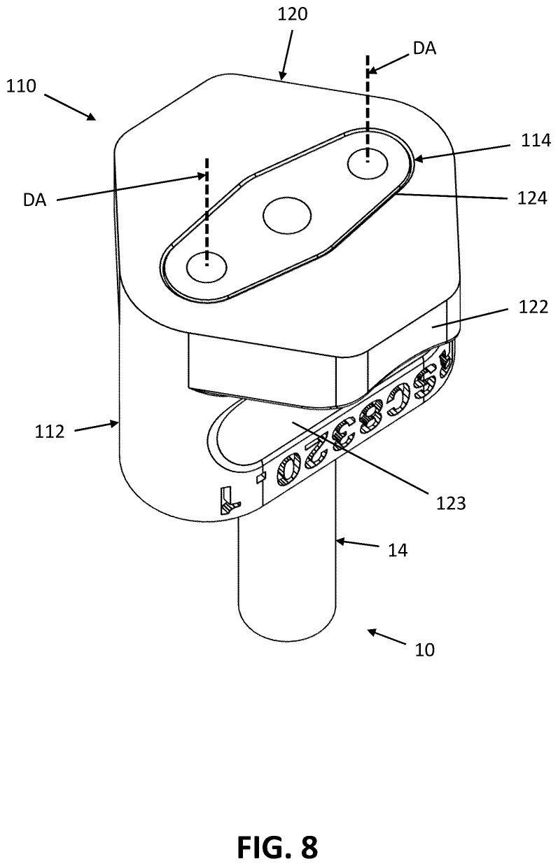

Referring now to FIGS. 2-6, an exemplary embodiment of a drill guide for removing the standoff 10 from the structure S is generally indicated at reference number 110. The drill guide 110 broadly comprises a fitting body 112 that defines a standoff receptacle 114 in which to receive a standoff 10 that has been fastened to a structure S. The fitting body 112 is configured to operably couple to the standoff 10 such that at least a portion of the standoff is received in the standoff receptacle 114. The fitting body 112 fits onto at least a portion of the standoff 10 in close tolerance such that the fitting body has a keyed position in relation to the standoff. A plurality of drill bushings 116 for guiding a drill bit along respective drilling axes DA are supported on the fitting body. When the fitting body 112 is in the keyed position (see FIGS. 7 and 8), it aligns the drill bushings 116 with the fasteners 16 of the standoff 10 so that the drilling axes DA are essentially coaxial with the axes of the fasteners 16. This way, each drill bushing 116 will precisely guide a drill bit along the respective drilling axis DA for drilling out a respective fastener 16. Thus, using the drill guide 110 facilitates removal of a standoff 110 from a structure S by drilling out the fasteners 16 and eliminates freehand drilling errors and associated damage to the structure.

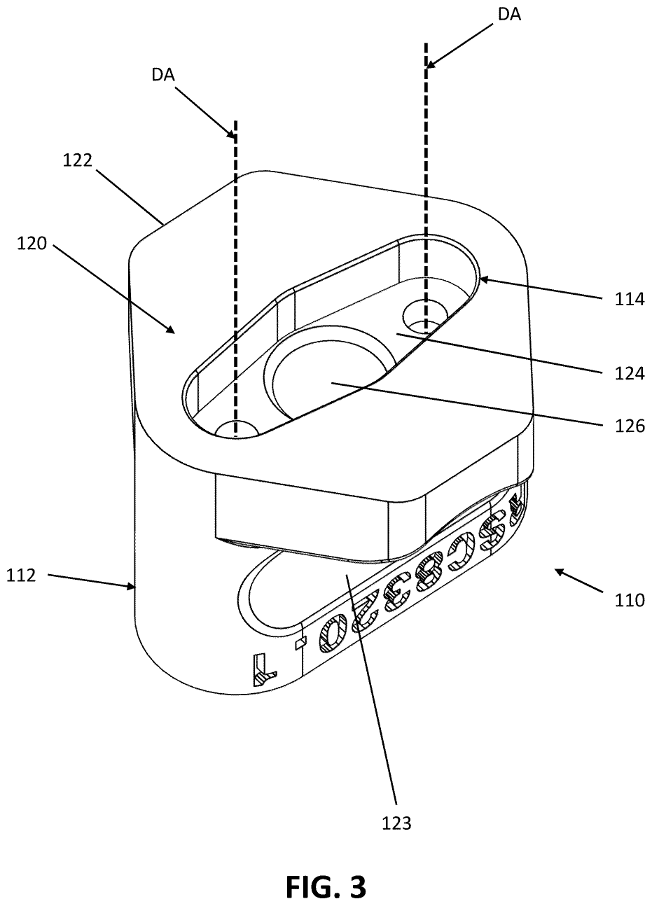

The fitting body 112 has a bottom portion and a top portion spaced apart along a height. The fitting body 112 suitably holds the drill bushings 116 so that the drilling axes DA run heightwise. The bottom portion of the fitting body 112 defines a flange fitting 120 (FIG. 3) around the standoff receptacle 114. The flange fitting 120 has an inner perimeter sized and shaped to match the outer perimeter of the flange 12 of the standoff 10 such that the flange fitting fits around the outer perimeter of the flange in close tolerance. In the illustrated embodiment, the bottom portion of the fitting body 112 comprises a pair of stabilizing feet 122 extending outward to provide a stable base for supporting the fitting body on the structure S when the fitting body is in the keyed position. Above the stabilizing feet 122, the fitting body 112 has a side wall 123 that extends heightwise from the bottom portion to the top portion. In the illustrated embodiment, the sidewall 123 extends 360 degrees about the standoff receptacle 114.

In certain embodiments, the side wall 123 can comprise finger contours that help a user firmly grip the fitting body 112 by hand during use. In one embodiment, the fitting body 112 is formed from plastic. For example, the fitting body can be additively manufactured to have a suitable standoff-specific shape that keys to the outer perimeter of a respective type of standoff.

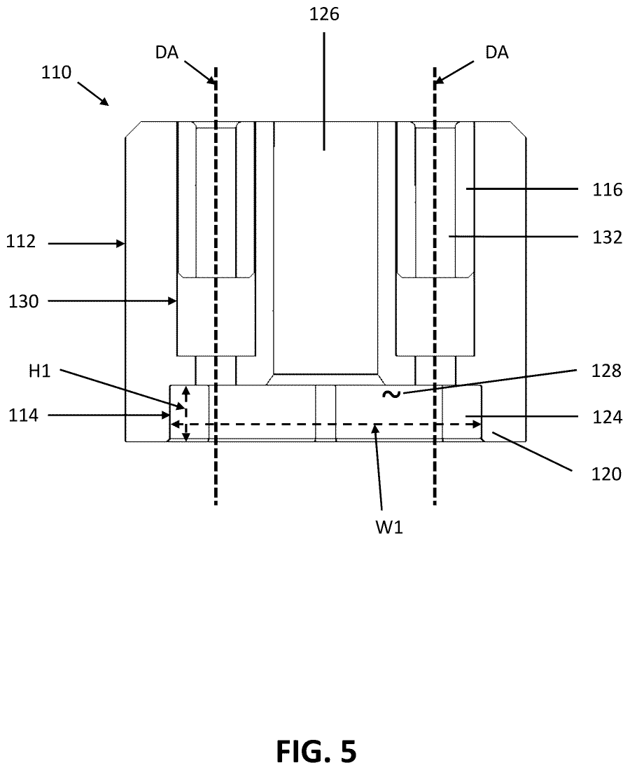

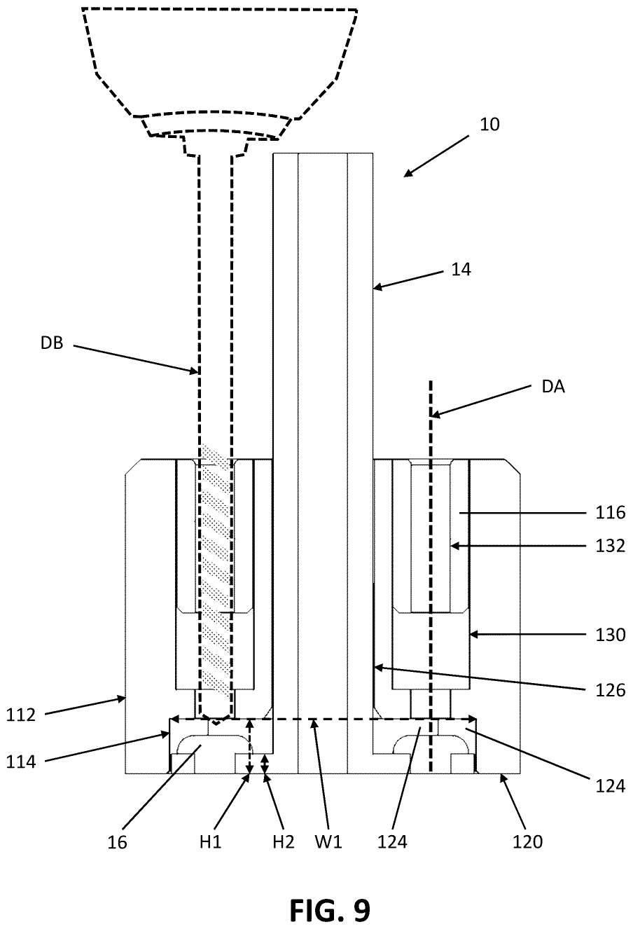

Referring to FIG. 5, the standoff receptacle 114 opens through the bottom portion of the fitting body 112 such that the drill guide 110 can be pressed down onto the standoff 10 to load the standoff into the standoff receptacle and thereby operably couple the drill guide to the standoff. The standoff receptacle 114 comprises a flange chamber 124 and an upper chamber 126 above the flange chamber. The flange fitting 120 defines and extends around the flange chamber 124. Thus the flange chamber is sized and arranged to match the outer perimeter of the flange 12 of the standoff 10. Hence the flange chamber 124 has a width W1 corresponding to the width of the standoff flange 12. The flange chamber 124 also has a height H1. As shown in FIG. 9, the height H1 of the flange chamber 124 is greater than a height H2 of the flange 12 such that the flange chamber is configured to provide headspace 128 above the flange for chip clearance when the fitting body 112 is operably coupled to the standoff 10. In other words, the headspace 128 provides clearance so that the drill chips formed while drilling out each fastener 16 have a place to accumulate until the process of removing the standoff 10 is complete.

Whereas the flange chamber 124 is sized and arranged to match the outer perimeter of the flange 16 of the standoff 10, the upper chamber 126 is sized and arranged to match the outer perimeter of the arm 14 of the standoff. Accordingly, the flange chamber 124 has a greater cross sectional area than the upper chamber 126 (e.g., the upper chamber is narrower than the flange chamber), and the upper chamber is located centrally along the width W1 of the flange chamber (e.g., in a comparable location to the standoff arm 14 in relation to the standoff flange 12). In the illustrated embodiment, the upper chamber 126 opens through the top portion of the fitting body 112. So when the illustrated fitting body 112 is in the keyed position (FIGS. 7-9), the upper portion of the arm 14 of the standoff 10 extends through the open top end of the upper chamber 126 and protrudes upward beyond the top end portion of the fitting body. It can be seen that the open top end of the upper chamber 126 can accommodate standoff arms of different lengths.

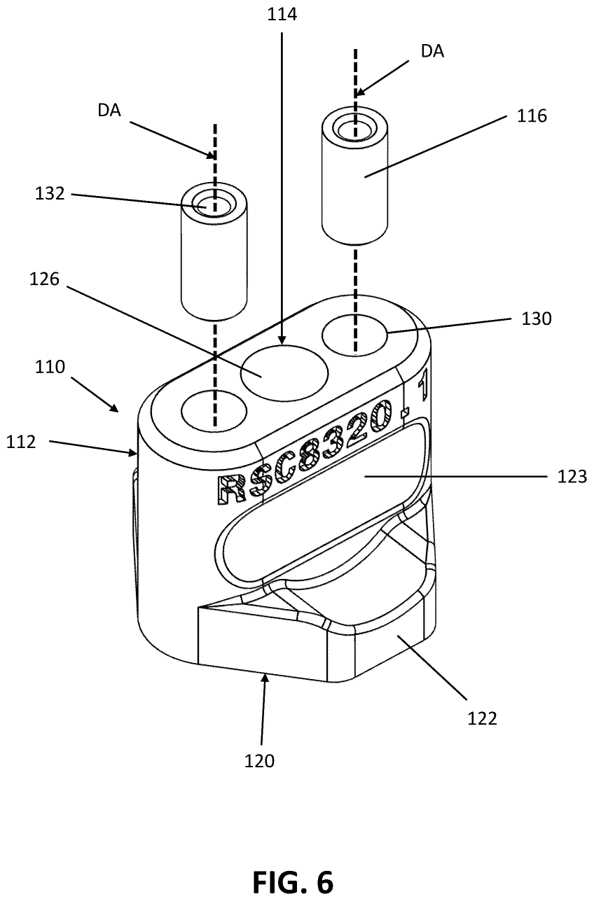

In addition to the standoff receptacle 114, the illustrated fitting body 112 defines a respective drill bushing passage 130 for each drill bushing 116. Thus as can be seen in FIGS. 5-6, the fitting body 112 comprises first and second drill bushing passages 130 spaced apart on opposite sides of the upper chamber 126 and above the flange chamber 124. Each drill bushing passage 130 extends heightwise and opens through the top portion and the bottom portion of the fitting body 112. Each drill bushing 116 is mounted (e.g., press fit) in a respective one of the drill bushing passages 130.

As explained above, the drill bushings 116 are configured to guide a drill bit DB as it drills out the fasteners 16 of the standoff 10. Suitably, the drill bushings 116 are made of a robust metal material (e.g., steel) that can withstand the friction from bearing on the drill bit DB as it drills out the fasteners 16. Each drill bushing 116 defines a drill bit passage 132 extending along a respective drilling axis DA. The drill bushings 116 are positioned above the flange chamber 124 of the standoff receptacle 114 such that each drilling axis DA crosses through the flange chamber. The upper chamber 126 is located between the bushings 116 widthwise. Referring to FIG. 8, each drill bushing 116 is positioned and arranged on the fitting body 112 to be directly above a respective one of the fasteners 16 when the fitting body is in the keyed position in relation to the standoff. Hence, each drill bushing 116 is configured to guide a drill bit DB (FIG. 9) inserted into the drill bit passage 132 along the drilling axis DA for drilling out the fastener 16.

An exemplary method of using the drill guide 110 to remove a standoff 10 from the structure S will now be briefly described. The method is carried out after a standoff 10 has been fastened to the structure S with fasteners 16 and is typically performed because the standoff was fastened in the wrong location. Initially, a technician press fits the drill guide 110 onto the standoff 10. This locates the flange 12 of the standoff 10 in the flange chamber 124 of a fitting body 112 and locates the arm 14 of the standoff in the upper chamber 126 of the fitting body. As a result, the drill guide 110 is positioned at the keyed position in relation to the standoff 10, which aligns the drilling axes DA of the drill bushings 116 to be essentially coaxial with the axes of the fasteners 16. Further, in the keyed position, the stabilizing feet 122 support the drill guide 110 on the structure and provide a stable footing.

As shown in FIG. 9, once the keyed position has been established, the technician inserts the drill bit DB into one of the drill bushings 116 and operates the drill (not shown). While drilling, the technician grips the side wall 123 of the fitting body 112 and uses the stabilizing feet 122 to stabilize the fitting body on the structure S. This maintains the fitting body 112 at the keyed position while the drill bushing 116 bears on the rotating drill bit DB to keep the drill bit centered on the drilling axis DA. Thus, as the technician advances the drill bit DB along the drilling passage 132, the drill guide 110 maintains coaxial alignment of the drill bit DB with the fastener 16 so that the drill bit accurately drills out the fastener. In one embodiment, the technician inserts the drill bit DB until the drill (not shown) bottoms out on the top end of the drill bushing 116, which indicates that the drill bit has advanced to the required depth for drilling out the fastener 16. In another embodiment, the technician visually determines when the drill bit DB has advanced to the desired depth.

The technician then removes the drill bit from the first drill bushing 116 and repeats the process of inserting the drill bit DB into the drill bushing 116 and drilling via the drill bushing until all of the fasteners 16 have been drilled out. At this point, the technician can twist the drill guide 110 to shear the standoff 10 from any remnant of the fasteners that remain embedded in the structure. The standoff 10 is thus removed from the structure and can be further removed from the drill guide 110. Once removed, the drill guide 110 can be reused for other standoffs as needed. In most cases, because the drill guide 110 properly aligns the drill bit DB with the fastener 16 during drilling, the standoff 10 will not be damaged and may be removed. However, it will be understood that standoffs can be discarded after being removed without departing from the scope of the disclosure.

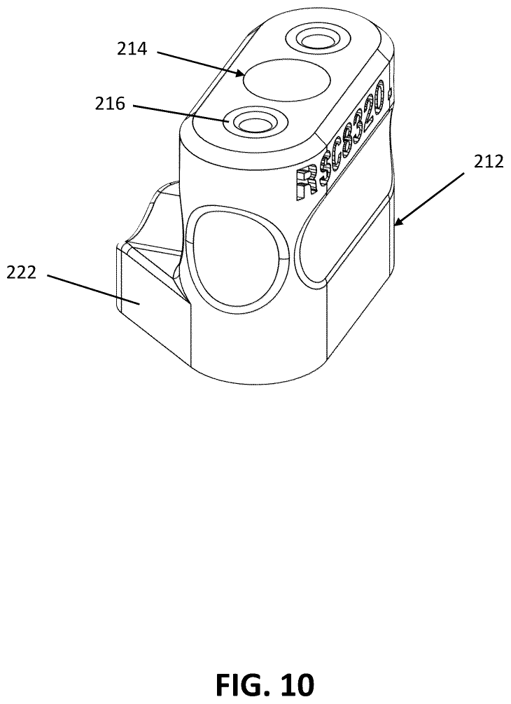

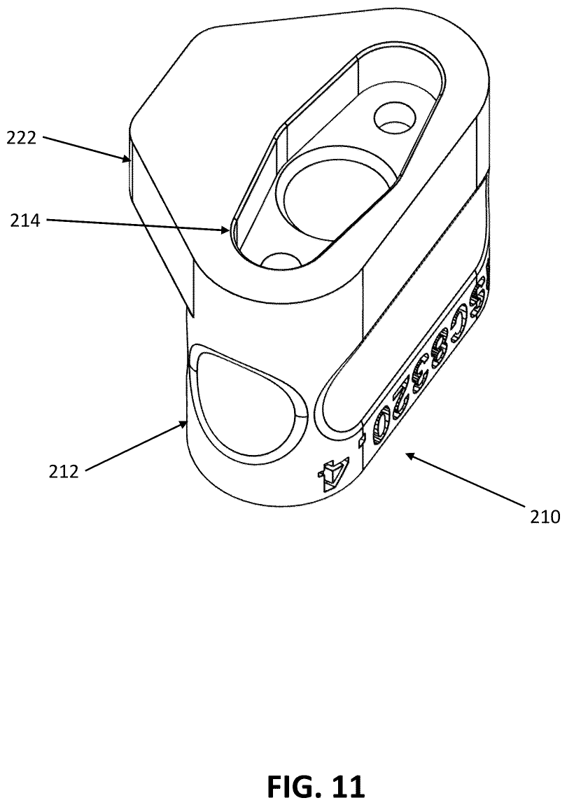

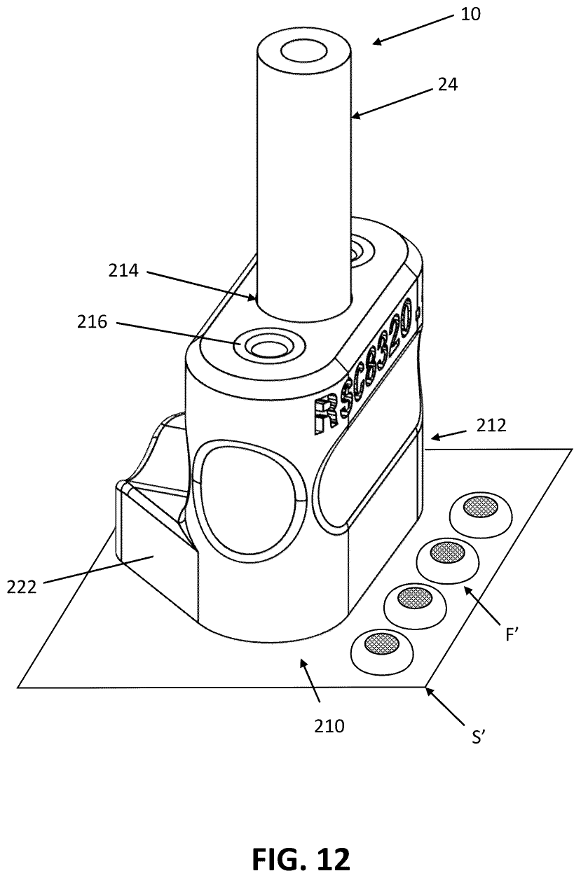

Referring to FIGS. 10-12, another embodiment of a drill guide for removing the standoff 10 from a structure S′ is generally indicated at reference number 210. The drill guide 210 is similar to the drill guide 110. Parts of the drill guide 210 that correspond with parts of the drill guide 110 are given the same reference number, plus 100. The drill guide 210 comprises a fitting body 212 defining a standoff receptacle 214 that is essentially identical to the standoff receptacle 114 of the fitting body 112. In addition, the fitting body 212 supports first and second drill bushings 216 at essentially the same positions as the drill bushings 116 on the fitting body 112. Accordingly, like the drill guide 110, the drill guide 210 is configured so that the fitting body 212 fits onto the standoff 10 at a keyed position where the drill bushings 216 are essentially coaxial with the axes of the fasteners 16 so that the drill bushings will guide a drill bit DB for drilling out the fasteners 16 of the standoff. The drill guide 210 differs from the drill guide 110 in that the fitting body 212 has only one stabilizing foot 222. The opposite side of the fitting body 212 is devoid of a stabilizing foot. This configuration enables the drill guide 210 to be used to remove a standoff 10 located on a structure S′ immediately adjacent to an edge feature F′ that would interfere with one of the stabilizing feet 122 of the drill guide 110. Otherwise, the drill guide 210 operates in the same way as the drill guide 110.

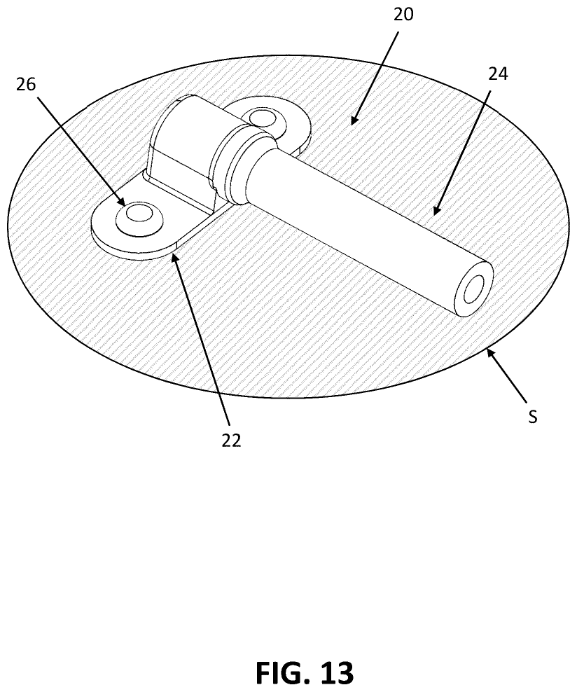

Referring to FIG. 13, another embodiment of a standoff is generally indicated at reference number 20. The standoff 20 is similar to the standoff 10, and therefore corresponding parts are given the same reference number, plus ten. The standoff 20 comprises a flange 22 supported on a structure S and an upstanding portion 24 extending from the flange. In the illustrated embodiment, the upstanding portion 24 comprises a horizontal arm extending outward from a central region of the flange. Fasteners 26 (e.g., rivets) extend through pre-drilled holes in the flange 22 and fasten the standoff 20 to the structure S. The fasteners 26 are located on opposite sides of the arm 24 such that the arm is centered widthwise between the fasteners.

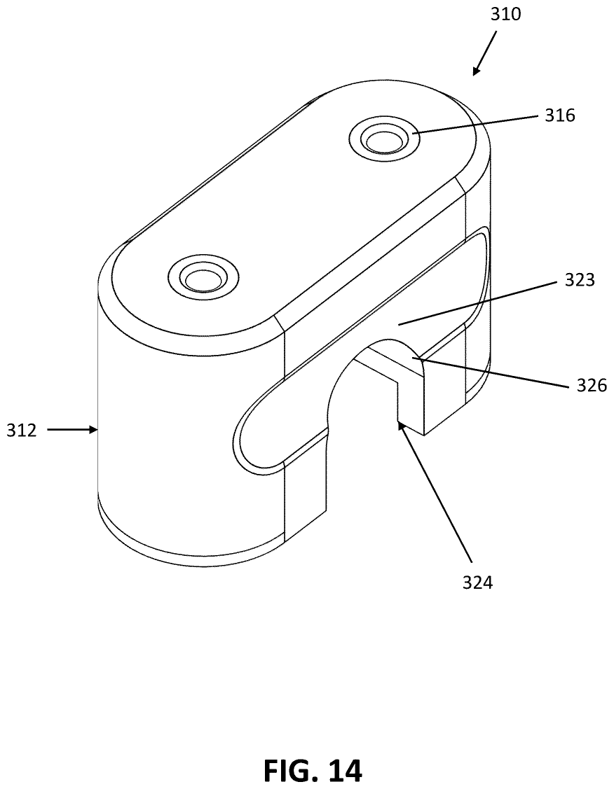

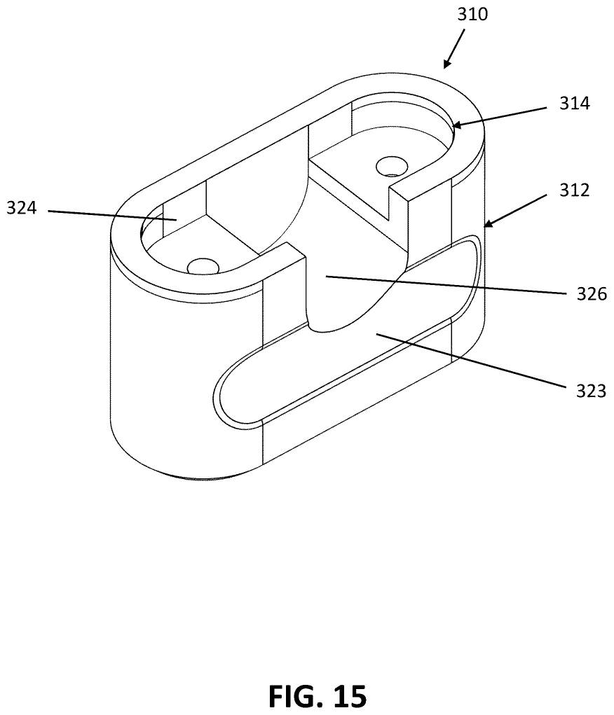

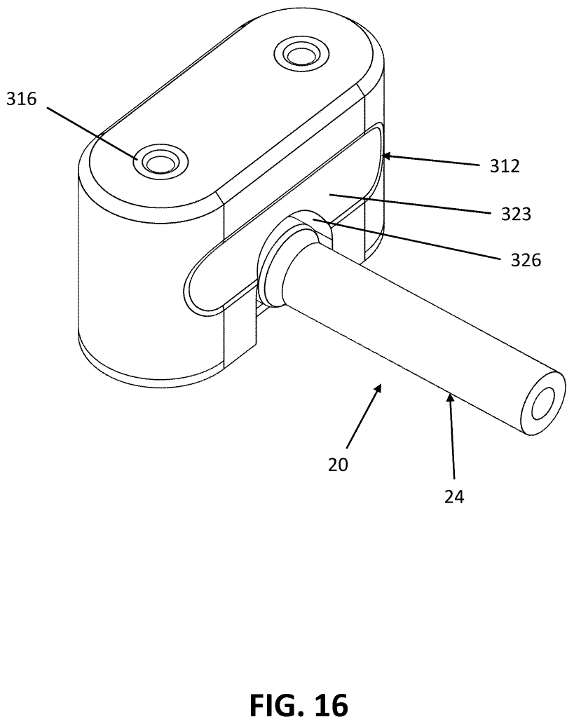

Referring to FIGS. 14-16, an exemplary embodiment of a drill guide for removing the standoff 20 from the structure S is generally indicated at reference number 310. The drill guide 310 is similar to the drill guide 110, and corresponding parts are given the same reference number, plus 200. The drill guide 310 comprises a fitting body 312 defining a standoff receptacle 314 in which to receive the standoff 20. Like the standoff receptacle 114, the standoff receptacle 314 includes a flange chamber 324 and an upper chamber 326 above the flange chamber. But unlike the standoff receptacle 114, the upper chamber 326 of the standoff receptacle 314 opens through the side wall 323 of the fitting body 312. Accordingly, the fitting body 312 is configured to be fitted onto the standoff 20 at a keyed position in which the proximal end portion of the horizontal arm 24 is received in the upper chamber 326 of the standoff receptacle 314 and the distal end portion extends outward through the opening in the side wall 323. As with the drill guide 110, the drill guide 310 comprises first and second drill bushings 316 supported on the fitting body 312 so that they are essentially coaxial with the axes of the fasteners 26 when the fitting body is in the keyed position relative to the standoff 20. Hence, in the same way that the drill guide 110 can be used to remove the standoff 10 from the structure S, the drill guide 310 can be used to remove the standoff 20 from the structure.

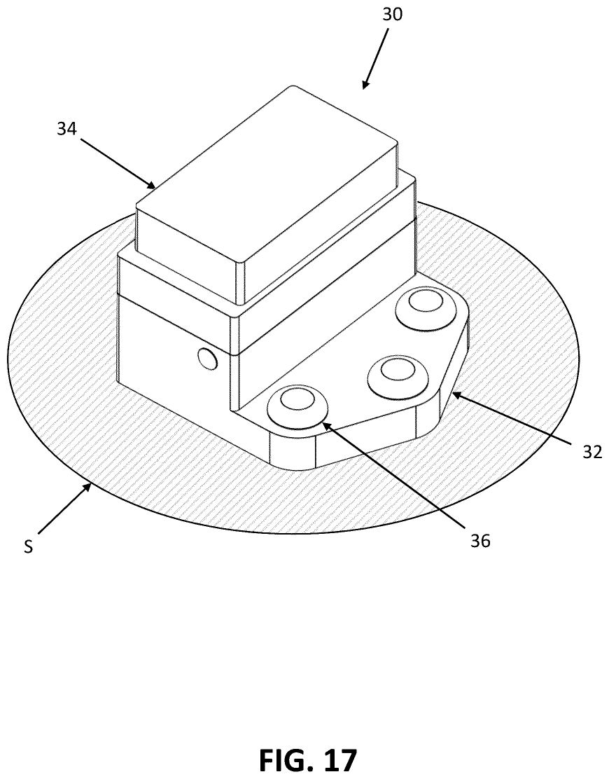

Referring to FIG. 17, another embodiment of a standoff is generally indicated at reference number 30. The standoff 30 is similar to the standoff 10, and therefore corresponding parts are given the same reference number, plus twenty. The standoff 30 comprises a flange 32 supported on the structure S and an upstanding portion 34 extending from the flange. In the illustrated embodiment, the upstanding portion 34 comprises a rectangular block element and the flange 32 extends outward on only one side of the rectangular block element. Three fasteners 36 (e.g., rivets) extend through pre-drilled holes in the flange 32 and fasten the standoff 30 to the structure S. The fasteners 36 are spaced apart along the width of the standoff 30.

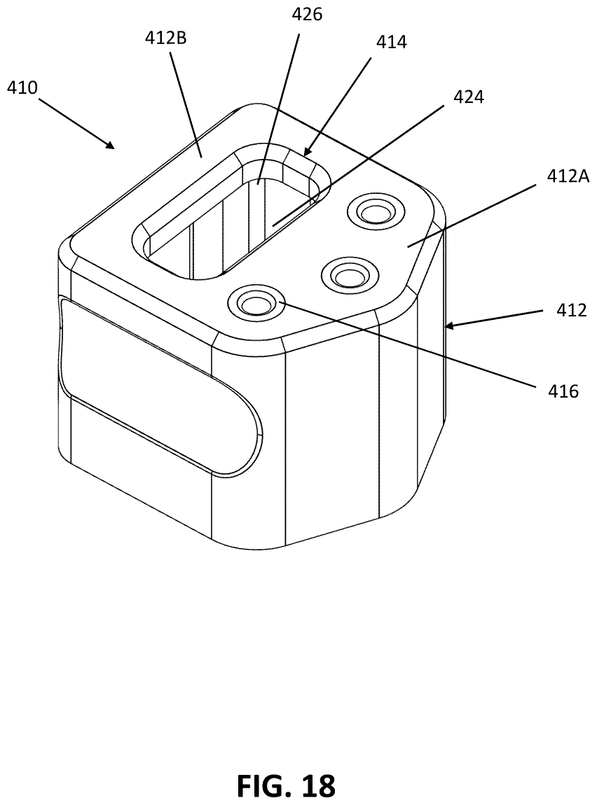

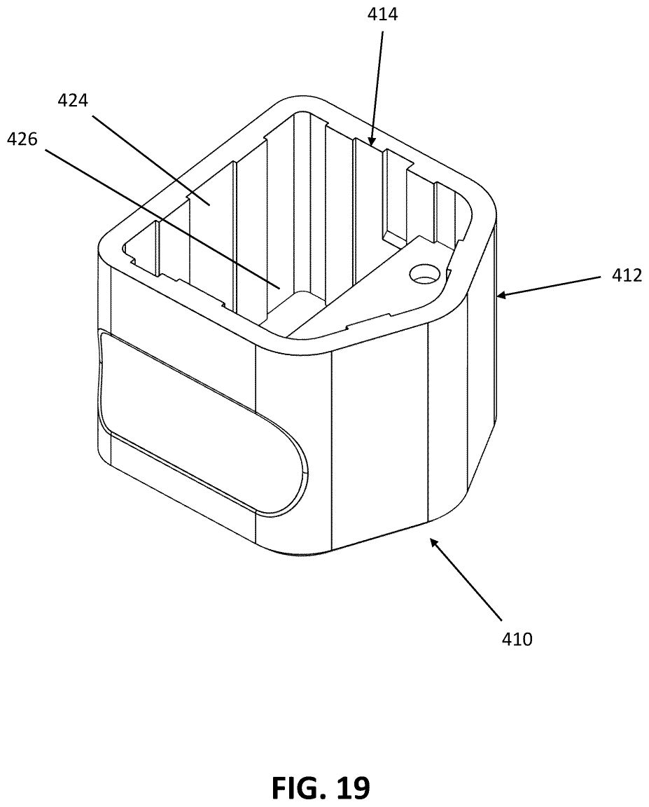

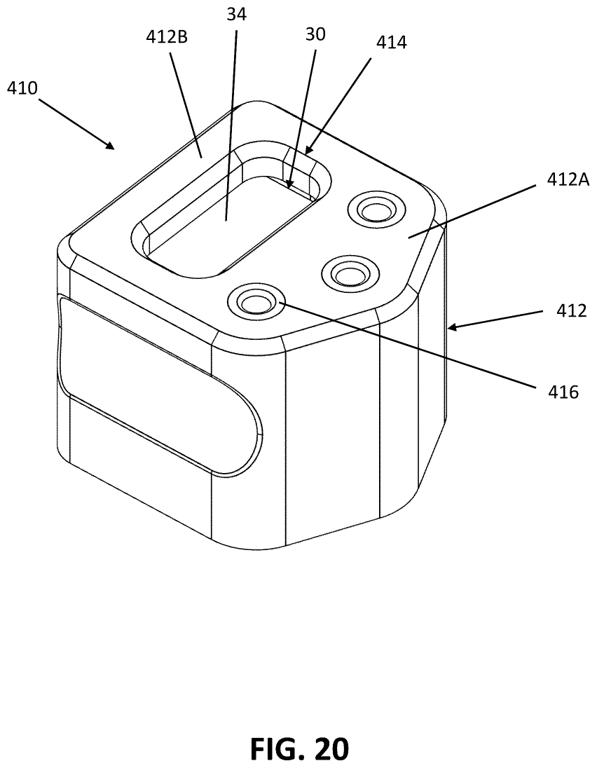

Referring to FIGS. 18-20, an exemplary embodiment of a drill guide for removing the standoff 20 from the structure S is generally indicated at reference number 410. The drill guide 410 is similar to the drill guide 110, except that it is configured for use with the standoff 30 instead of the standoff 10. Parts of the drill guide 410 that correspond with parts of the drill guide 110 are given the same reference number, plus 300. The drill guide 410 comprises a fitting body 412 having a forward region 412A and a rear region 412B. The fitting body comprises a standoff receptacle 414 including a flange chamber 424 and an upper chamber 426 above the flange chamber. The upper chamber 426 is narrower than the flange chamber and located at the rear region 412B of the fitting body 412. The fitting body comprises first, second, and third drill bushings 416 located at the forward region of the fitting body above the flange chamber 424. The fitting body 412 is configured to receive the standoff 30 in the standoff receptacle 414, whereby the fitting body fits on the standoff at a keyed position. In the keyed position, the first, second, and third drill bushings align with the three fasters 36 used to secure the standoff 30 to the structure S. Accordingly, the drill guide 410 can be used to remove the standoff 30 from the structure S in essentially the same way that the drill guide 110 is used to remove the standoff 10.

The drill guide provides several distinct advantages over the current tools and methods for removing standoffs. The time needed to remove a misaligned or misplaced standoff is significantly reduced by the drill guide and corresponding method of removal. Rather than drill by hand, a technician may quickly insert the standoff into the drill guide and begin drilling immediately. There is no need to create a divot in the center of the fastener, no need to continually assess the alignment of the drill bit along a drilling axis, nor a need to stabilize the standoff by hand. In addition to the obvious improvements in speed, the drill guide greatly increases safety for both the user and the structure. Because the drill guide uses the standoff as a stabilizing structure, there is little possibility that the drill bit will slip and strike the user, the standoff, or the structure to which the standoff is fastened.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

1. A drill guide for removing a standoff fastened to a structure by a plurality of fasteners, the drill guide comprising:
a fitting body having a bottom portion and a top portion spaced apart along a height, the fitting body defining a standoff receptacle opening through the bottom portion of the fitting body, the fitting body configured to operably couple to the standoff such that at least a portion of the standoff is received in the standoff receptacle such that the fitting body has a keyed position in relation to the standoff, wherein the bottom portion of the fitting body defines a flange fitting around the standoff receptacle, the standoff receptacle comprises a flange chamber defined by the flange fitting, and the standoff receptacle further comprises an upper chamber above the flange chamber, wherein the fitting body defines a plurality of drill bushing passages; and
a plurality of drill bushings secured to the fitting body, each drill bushing being received in a respective drill bushing passage and defining a drill bit passage extending along a respective drilling axis, each drill bushing being positioned and arranged on the fitting body to be directly above a respective one of the fasteners when the fitting body is in the keyed position in relation to the standoff such that the drill bushing is configured to guide a drill bit inserted into the drill bit passage along the drilling axis for drilling out the fastener, wherein each said drilling axis crosses through the flange chamber and is located entirely outside of the upper chamber;
wherein the upper chamber has a first width and each of the plurality of drill bushing passages has a second width, wherein the first width is greater than the second width.

2. (canceled)

3. (canceled)

4. The drill guide as set forth in claim 1, wherein the flange chamber is configured to provide headspace above the flange for chip clearance when the fitting body is operably coupled to the standoff.

5-7. (canceled)

8. The drill guide as set forth in claim 1, wherein the upper chamber opens through the top portion of the fitting body.

9. The drill guide as set forth in claim 1, wherein the fitting body has a side wall between the bottom portion and the top portion, the upper chamber opening through the side wall.

10. The drill guide as set forth in claim 1, wherein the fitting body defines at least one drill bushing passage beside the upper chamber and above the flange chamber.

11. The drill guide as set forth in claim 1, wherein the fitting body defines at least one drill bushing passage, each drill bushing passage extending heightwise and opening through the top portion and the bottom portion of the drill guide body.

12. The drill guide as set forth in claim 11, wherein each drill bushing is mounted in a respective one of the drill bushing passages.

13. The drill guide as set forth in claim 1, wherein:
the flange chamber has a width;
the upper chamber is narrower than the flange chamber and located centrally along the width of the flange chamber;
the plurality of bushings comprises a first bushing and a second bushing;
the first bushing, the upper chamber, and the second bushing being spaced apart widthwise; and
the upper chamber being located between the first bushing and the second bushing along the width of the flange chamber.

14. The drill guide as set forth in claim 1, wherein:
the fitting body comprises a forward region and a rear region;
the standoff receptacle comprises a flange chamber;
the standoff receptacle further comprises an upper chamber above the flange chamber, the upper chamber being narrower than the flange chamber and located at the rear region of the fitting body;
the plurality of bushings comprising a first bushing, second bushing, and third bushing;
the first bushing, second bushing, and third bushing are located at the forward region of the fitting body; and
the first bushing, second bushing, and third bushing are located above the flange chamber.

15. The drill guide as set forth in claim 1, wherein the lower portion of the fitting body comprises at least one stabilizing foot extending outward to provide a base for supporting the fitting body on the structure when the fitting body is in the keyed position.

16. A method of removing a standoff from a structure after the standoff has been fastened to the structure with a plurality of fasteners, the method comprising:
press fitting a drill guide as set forth in claim 1 onto the standoff whereby the drill guide is positioned at a keyed position in relation to the standoff; and
using each of a plurality of drill bushings of the drill guide to guide a drill bit along respective drilling axes to drill out a respective fastener securing the standoff to the structure.

17. The method as set forth in claim 16, wherein said press fitting comprises locating a flange of the standoff in a flange chamber of a fitting body of the drill guide and locating an upper portion of the standoff in an upper chamber of the fitting body.

18. The method as set forth in claim 16, further comprising;
removing the standoff from the fitting body;
shearing the fasteners; and
applying an upward force to the standoff until said standoff disconnects from said structure.

19. The method of removing a standoff as set forth in claim 16, further using a stabilizing foot of the drill guide to stabilize the drill guide on the structure while drilling.

20. A method of removing a standoff as described in claim 16, further comprising gripping the drill guide by hand while drilling.
